(19) United States
(12) Patent Application Publication
(10) Pub. No.: US 2021/0011755 A1
(43) Pub. Date: Jan. 14, 2021

(54) SYSTEMS, METHODS, AND DEVICES FOR POOLED SHARED/VIRTUALIZED OR POOLED MEMORY WITH THIN PROVISIONING OF STORAGE CLASS MEMORY MODULES/CARDS AND ACCELERATORS MANAGED BY COMPOSABLE MANAGEMENT SOFTWARE

(71) Applicant: Shreyas Shah, Sanjose, CA (US)

(72) Inventor: Shreyas Shah, Sanjose, CA (US)

(21) Appl. No.: 16/505,718

(22) Filed: Jul. 9, 2019

(51) Int. Cl. G06F 9/46; G06F 9/50; G06F 12/1009; G06F 13/16; G06F 13/28; G06N 3/06; H04L 29/12

(52) U.S. Cl. CPC G06F 9/467; G06F 9/5016; G06F 12/1009; H04L 61/6022; G06F 13/28; G06N 3/06; G06F 13/1668

(57) ABSTRACT

Provided are systems, methods, and devices for management of storage class memory modules. Methods include receiving a request from an application running on a server, the request received at a memory controller, and maintaining a page table comprising page numbers, server numbers, storage class memory (SCM) dual-inline memory module (DIMM) numbers, and pointers mapping blocks of memory to SCM DIMMs in devices connected to the server through a network interface. The methods also include allocating memory using the request from the application, wherein whether the memory is locally allocated or remotely allocated remains transparent to the application.

### TECHNICAL FIELD

The present disclosure relates to memory modules, and more specifically, to persistent memory modules. The shared memory pools and allocation of memory to applications running on servers dynamically on demand. The thin provisioned memory or shared/virtualized pooled memories with accelerators (As an example not limited to Comp/de-comp, TLS, IPSec, Erasure codes, RSA2K/4K, SHA1,2,3, AES-XTS) and managed by compasable management infrastructure dynamically allocates and de-allocated the memory from a shared pool of persistent memory.

Servers may include a central processing unit, a hardware accelerator coupled to the central processing unit, a network input/output (I/O) chip coupled to the central processing unit. The servers may also include a storage class memory (SCM) dual-inline memory module (DIMM) coupled to the central processing unit through the central processing unit interface, coupled to the hardware accelerator through a hardware accelerator interface, and coupled to the network I/O chip through a network interface included in the SCM DIMM.

Storage class memory appliances may include a network switch interface and a control processor connected to the network switch interface, wherein the storage class memory appliances are coupled to network switches coupling a plurality of servers to the storage class memory appliances. The storage class memory appliances may also include a plurality of storage class memory (SCM) dual-inline memory modules (DIMMs) coupled to the network switch interface, wherein the SCM DIMMs are configured to provide a pool of shared persistent memory to the plurality of servers through the use of memory translation tables included at the plurality of servers, the memory translation tables including a plurality of page table pointers and a plurality of MAC addresses, wherein the plurality of the SCM DIMMs are coupled to a plurality of processing units.

### BACKGROUND

Computer systems may include storage devices and memory modules that are configured to store data values that may be utilized in computational operations. Such memory modules may be random access memory (RAM) memory modules that have low latencies, but are not persistent. Accordingly, when powered off, any information stored in such memory modules is lost. Storage devices may be devices such as disk drives that provide persistent storage that is retained after being powered down. However, such storage devices have large latencies resulting in relatively long read and write latencies.

### SUMMARY

Provided are systems, methods, and devices for persistent memory modules.

In various embodiments, systems, methods, and devices are provided for storage class memory (SCM) dual in-line memory modules (DIMMs). SCMs may include a memory controller associated with the SCMs, the memory controller being configured to control the flow of data between a processing unit and the SCMs using a plurality of transactions including read and write transactions. The SCMs may also include a plurality of SCM persistent memory integrated circuits included on the SCMs. The SCMs may also include a network interface included on the SCMs, the network interface having a unique Media Access Control address, wherein the SCMs are operable to conduct data transfers over the network interface while bypassing the processing unit.

This and other embodiments are described further below with reference to the figures (FIG. 1 to FIG. 4).

Provided are systems, methods, and devices for intracranial measurement, stimulation, and generation of brain state models.

In various embodiments, servers may include a central processing unit, a hardware accelerator coupled to the central processing unit, a network input/output (I/O) chip coupled to the central processing unit. The servers may also include a storage class memory (SCM) dual-inline memory module (DIMM) coupled to the central processing unit through the central processing unit interface, coupled to the hardware accelerator through a hardware accelerator interface, and coupled to the network I/O chip through a network interface included in the SCM DIMM.

This and other embodiments are described further below with reference to the figures (FIG. 5 to FIG. 8).

Provided are systems, methods, and devices for persistent memory modules.

In various embodiments, storage class memory appliances may include a network switch interface and a control processor connected to the network switch interface, wherein the storage class memory appliances are coupled to network switches coupling a plurality of servers to the storage class memory appliances. The storage class memory appliances may also include a plurality of storage class memory (SCM) dual-inline memory modules (DIMMs) coupled to the network switch interface, wherein the SCM DIMMs are configured to provide a pool of shared persistent memory to the plurality of servers through the use of memory translation tables included at the plurality of servers, the memory translation tables including a plurality of page table pointers and a plurality of MAC addresses, wherein the plurality of the SCM DIMMs are coupled to a plurality of processing units.

This and other embodiments are described further below with reference to the figures (FIG. 9-FIG. 12).

Provided are systems, methods, and devices for persistent memory modules.

In various embodiments, methods include receiving a request from an application running on a server, the request received at a memory controller, and maintaining a page table comprising page numbers, server numbers, storage class memory (SCM) dual-inline memory module (DIMM) numbers, and pointers mapping blocks of memory to SCM DIMMs in devices connected to the server through a network interface. The methods also include allocating memory using the request from the application, wherein whether the memory is locally allocated or remotely allocated remains transparent to the application.

This and other embodiments are described further below with reference to the figures (FIG. 13-FIG. 16).

### BRIEF DESCRIPTION OF THE DRAWINGS

FIG. 1 illustrates an example of a device including storage class memory, configured in accordance with some embodiments.

FIG. 2 illustrates an example of a system including storage class memory, configured in accordance with some embodiments.

FIG. 3 illustrates an example of another system including storage class memory, configured in accordance with some embodiments.

FIG. 4 illustrates an example of yet another system including storage class memory, configured in accordance with some embodiments.

FIG. 4A illustrates an example of yet another system including storage class memory, configured in accordance with some embodiments.

FIG. 5 illustrates an example of a system including storage class memory, configured in accordance with some embodiments.

FIG. 6 illustrates an example of a system including storage class memory, configured in accordance with some embodiments.

FIG. 7 illustrates an example of a device including storage class memory, configured in accordance with some embodiments.

FIG. 8 illustrates an example of yet another system including storage class memory, configured in accordance with some embodiments.

FIG. 9 illustrates an example of a system including storage class memory appliances, configured in accordance with some embodiments.

FIG. 10 illustrates an example of a storage class memory appliance, configured in accordance with some embodiments.

FIG. 11 illustrates an example of another storage class memory appliance, configured in accordance with some embodiments.

FIG. 12 illustrates an example of a device including storage class memory, configured in accordance with some embodiments.

FIG. 13 illustrates an example of a system including storage class memory, configured in accordance with some embodiments.

FIG. 14 illustrates another example of a system including storage class memory, configured in accordance with some embodiments.

FIG. 15 illustrates an example of a device including storage class memory, configured in accordance with some embodiments.

FIG. 16 illustrates an example of a method for using storage class memory, implemented in accordance with some embodiments.

### DETAILED DESCRIPTION OF EXAMPLE EMBODIMENTS

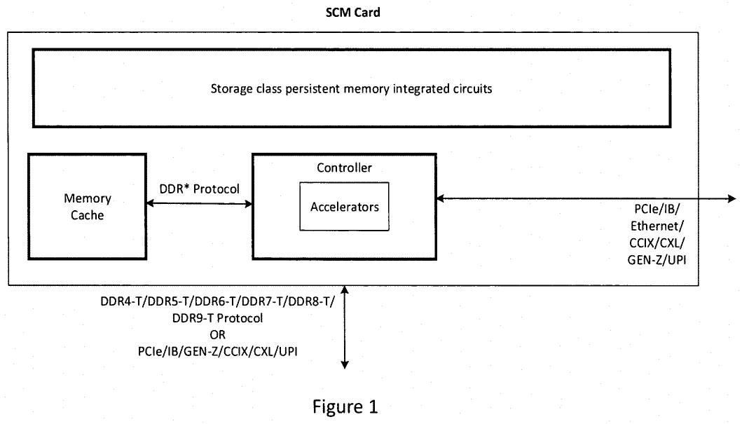

Reference will now be made in detail to some specific examples of the invention including the best modes contemplated by the inventors for carrying out the invention. Examples of these specific embodiments are illustrated in the accompanying drawings, i.e. FIG. 1 to FIG. 4. While the present disclosure is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In addition, although many of the components and processes are described below in the singular for convenience, it will be appreciated by one of skill in the art that multiple components and repeated processes can also be used to practice the techniques of the present disclosure.

In the following description, numerous specific details are set forth in order to provide a thorough understanding of the present invention. Particular embodiments of the present invention may be implemented without some or all of these specific details. In other instances, well known process operations have not been described in detail in order not to unnecessarily obscure the present invention.

As will be discussed in greater detail below, systems disclosed herein are configured to create storage class memory dual in-line memory modules (SCM DIMMs) that are configured to implement any DDR protocols (e.g. DDR4/DDR5/DDR6/DDR7/DDR8, LPDDRx, or HBM* protocols) with connectivity of any generation of PCIe/IB/Ethernet/UPI/CXL/GEN-Z connectivity. In this way, systems and devices implementing such SCM devices are able to carve out their own memory as private memory and shared pool memory. The shared portion can be shared via CXL/UPI/GEN-Z/PCIe/IB/Ethernet switches and routers connected as end points in the network. In various embodiments, memory controllers included in the SCM devices are configured to cache memory pages, implement a learning engine based on AI algorithms to prefetch the pages to reduce the latency, and implement various security measures (SHA*, IPSec*, SSL*, ECDA*) to send/receive data securely on PCIe/IB/Ethernet/CXL/GEN-Z/UPI network. The memory controller can be accessed as K/V pair where Key is supplied and the return value (entire page or multiple pages or a portion of page) can be delivered to requestor.

Moreover, as will be discussed in greater detail below, the implementation of such SCM DIMMS creates persistent storage that has a relatively low latency that is lower than conventional persistent storage, while also having a storage capacity that is higher than conventional RAM storage. For example, SCM devices as disclosed herein may have storage capacities several times larger than conventional DRAM, and may have access speeds that are greatly increased over conventional persistent storage devices.

In various embodiments, management and control is also provided to the connected SCM devices to create memory centric computing. Such embodiments, may also be used to create a memory centric acceleration plane in a data center or across multiple data centers. The management of shared memory will manage the local memory vs the global pool. The management may be implemented by a number of servers and can serve one or more data centers.

In various embodiments, there are no specific driver requirements to access SCM DIMMs. The size of an SCM DIMM may appear infinite (infinite memory) to an associated processing or accelerator unit, and such memory may be configured and defined in an SPD (Serial presence detect) of the SCM device.

When the SCM devices disclosed herein are used to create GPU/AI clusters, the interface to SCM devices may be either standard DDR* or LPDDR* or GDDR*. The configurable IO of the memory controller will provide access based on the interface protocol requirement.

As will be discussed in greater detail below, a cache, which may be a DDR cache, may be used to store some of the frequently accessed pages. These pages are learnt and identified based on application access patterns. In some embodiments, an AI algorithm is implemented to learn these access patterns and access the data apriori to reduce the latency to data.

In various embodiments, a networking and storage stack may be implemented as is for a server and application. A hardware/controller uses the networking protocol to transfer the data. This protocol will be reliable protocol over UDP/IP/Ethernet for scalability. Retransmissions are handled by hardware of the SCM devices such that no software driver is required by a processor/application associated with the SCM devices.

In various embodiments, management servers keep track of pages/local memory vs global memory pool. The segregation of the memory may be implemented at the time of boot. During runtime, the memory exposed to an application is infinite and the rest of the memory will be accessed by other servers in a rack or across the entire data center.

In some embodiments, an application accesses memory as if an infinite amount of memory exists. The application allocates the memory and if it is not available, a management server is notified and some part of the global pool of memory is reserved.

The reserved memory will be accessed by application.

According to various embodiments, all the accelerator units (which may be GPUs or ASICs) together appear as one large accelerator unit having billions of gates/cores, and higher level software implemented in one or more management servers may partition the work (processing operations) across multiple accelerator units.

FIG. 1 illustrates an example of a device including storage class memory, configured in accordance with some embodiments. As discussed above, SCM devices as disclosed herein are configured to store data values that may be utilized in computational operations. As will be discussed in greater detail below, SCM devices disclosed herein are dual in-line memory modules (DIMMs) that are configured to couple with other system components via DIMM slots and utilizing one or more protocols, such as DDR4-T/DDR5-T/DDR6-T/DDR7-T/DDR8-T/DDR9-T as well as DDR4/DDR5/DDR6/DDR7/DDR8. As will also be discussed in greater detail below, such SCM devices are configured to implement persistent storage at such DIMM slots, and in a manner that may bypass another system component, such as a processing unit, to implement various transactions, such as read and write transactions.

In various embodiments SCM devices may include SCM persistent memory integrated circuits configured to implement persistent storage of data values. Accordingly, such SCM persistent memory integrated circuits are configured to provide addressable memory that is configured to store data values in a persistent manner that retains data after the device has been shut off. As will be discussed in greater detail below, such data values may be read and written to and from SCM persistent memory integrated circuits utilizing memory transactions, such as read and write transactions.

In some embodiments, SCM devices may include a memory cache which is a memory device configured to store frequently utilized data values. For example, memory cache is configured to store frequently accessed pages. These pages are identified based on one or more identified access patterns. For example, an application utilizing the SCM devices may access the data values stored in the SCM persistent memory integrated circuits in accordance with a particular pattern. One or more components of the SCM devices, such as a memory controller discussed in greater detail below, may be configured to identify and learn these access patterns and access the data apriori to reduce the latency to data.

As discussed above, an SCM device may also include a memory controller that is configured to control the flow of data between a processing unit and the SCM device using a plurality of transactions including read and write transactions. As shown in FIG. 1, the memory controller may be coupled to the memory cache and SCM persistent memory integrated circuits. Moreover, as will be discussed in greater detail below, the memory controller may also be coupled to other system components, such as a processor, and other SCM devices via a communications interface and a network interface, respectively. In some embodiments, the memory controller has a configurable I/O that is configured to implement a particular transfer protocol. For example, the memory controller may be configured to implement a protocol consistent with DDR* or LPDDR* or GDDR*.

In various embodiments, the memory controller is configured to configure and define portions of the memory provided by the SCM persistent memory integrated circuits. For example, the memory controller is configured to define a local pool of memory that is utilized by the system or device that is coupled to the SCM device. The memory controller is also configured to define a shared pool of memory that may be utilized by other network attached SCM devices. In this way, a portion of the memory of the SCM device may form a portion of a shared pool of memory that may be allocated to and utilized by processing units or accelerator units in communication with the SCM devices participating in the shared pool. In various embodiments, the memory controller is also configured to track the amount of memory included in the local and shared portions of its associated SCM device, and may store that information in a serial presence detect (SPD) portion of the SCM device.

In various embodiments, SCM devices may further include a network interface that is configured to facilitate transactions between the SCM persistent memory integrated circuits and other SCM devices. In various embodiments, the network interface has a unique Media Access Control (MAC) address. Moreover, the network interface is configured to facilitate data transfers. In some embodiments, the network interface may be a PCI express interface or an Ethernet port. Accordingly, the network interface may be communicatively coupled to a communications network, and may enable communication between the memory controller, as well as the SCM persistent memory integrated circuits, and memory controllers and SCM persistent memory integrated circuits of other SCM devices. In this way, SCM devices are configured to conduct data transfers via the network interface in a manner that bypasses other components, such as a processing unit.

In some embodiments, SCM devices may also include a communications interface that is configured to enable communications with one or more other system components. For example, the communications interface may enable communications between the SCM devices and a processing unit, as will be discussed in greater detail below. Accordingly, the communications interface is coupled to the memory controller and is configured to facilitate communications between the memory controller and the processing unit. In some embodiments, the communications interface includes pins that may be inserted in a DIMM slot.

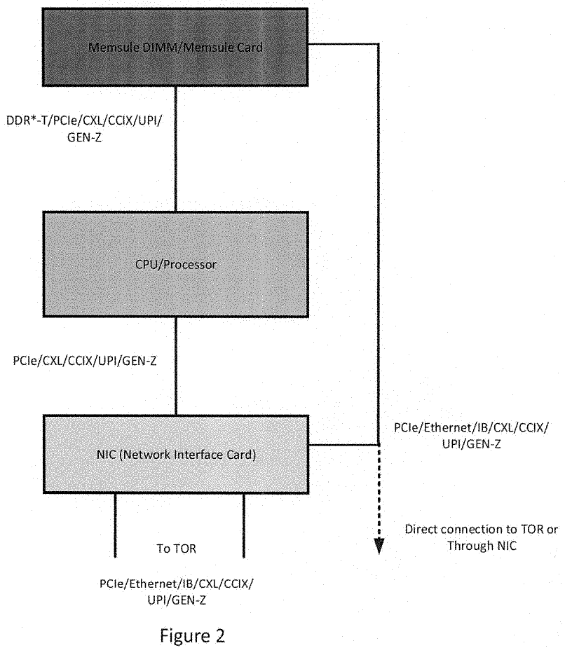

FIG. 2 illustrates an example of a system including storage class memory, configured in accordance with some embodiments. As discussed above, SCM devices as disclosed herein are configured to store data values that may be utilized in computational operations, and such SCM devices are configured to implement persistent storage at DIMM slots, and in a manner that may bypass another system component, such as a processing unit, to implement various transactions, such as read and write transactions.

Accordingly, systems may include an SCM device, such as an SCM DIMM, that is configured as discussed above with reference to FIG. 1. Accordingly, an SCM device may include SCM persistent memory integrated circuits, a memory cache, a memory controller, and the appropriate interfaces, such as a network interface and a communications interface. As shown in FIG. 2, the SCM device may be coupled to a processing unit which may be a central processing unit (CPU) of a system or device in which the SCM device is implemented, such as a server implemented in a data center.

Moreover, the SCM device and the processor may be coupled to a dedicated network device, which may be a network input/output (I/O) chip. As shown in FIG. 2, the SCM device and the processor may be coupled to the network device in parallel. In this way, the SCM device may communicate with other SCM devices via the network device in a manner that bypasses the processor.

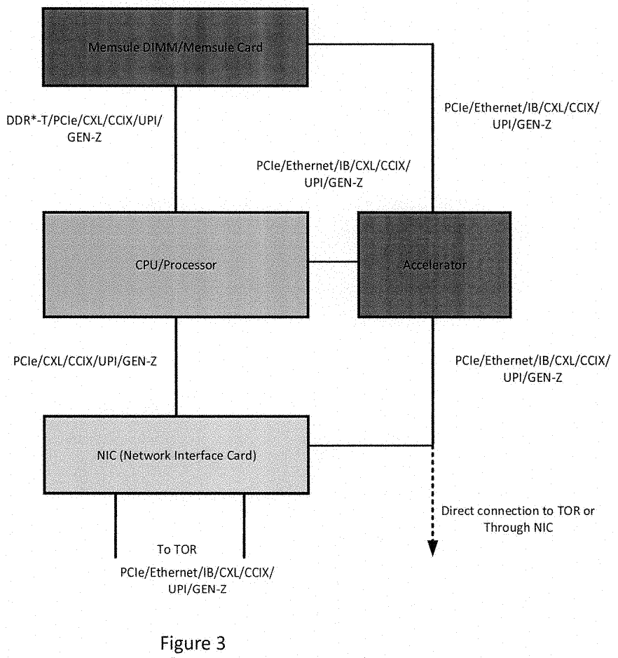

FIG. 3 illustrates an example of another system including storage class memory, configured in accordance with some embodiments. As similarly discussed above, SCM devices as disclosed herein are configured to store data values that may be utilized in computational operations, and such SCM devices are configured to implement persistent storage at DIMM slots, and in a manner that may bypass another system component, such as a processing unit. As shown in FIG. 3, such SCM devices may be implemented in systems that also include accelerator units. In this way, SCM devices may communicate directly with accelerator units in a manner that bypasses the processor, which may be a CPU.

Accordingly, as discussed above, an SCM device, such as an SCM DIMM, may be configured as discussed above with reference to FIG. 1. Accordingly, an SCM device may include SCM persistent memory integrated circuits, a memory cache, a memory controller, and the appropriate interfaces, such as a network interface and a communications interface. As shown in FIG. 3, the SCM device may be coupled to a processing unit which may be a central processing unit (CPU) of a system or device in which the SCM device is implemented, such as a server implemented in a data center. As similarly discussed above, the processor may be coupled to a dedicated network device, which may be a network input/output (I/O) chip.

As also shown in FIG. 3, the SCM device may be coupled to an accelerator unit that may be a hardware accelerator configured to implement specific processing functions. Accordingly, the hardware accelerator may be an application specific integrated circuit (ASIC). In some embodiments, accelerator unit is a graphics processing unit (GPU). Accordingly, the SCM device may be configured to directly communicate with a GPU, or a cluster of GPUs. In various embodiments, accelerator unit is a neural processing unit (NPU) configured to implement one or more machine learning operations. Accordingly, when configured as an NPU, the accelerator unit is configured accelerate machine learning operations implemented by systems disclosed herein.

In this way, the SCM device may be configured to communicate directly with one or more accelerator units, and may be configured to implement read and write transactions directly with such accelerator units in a manner that bypasses the processor.

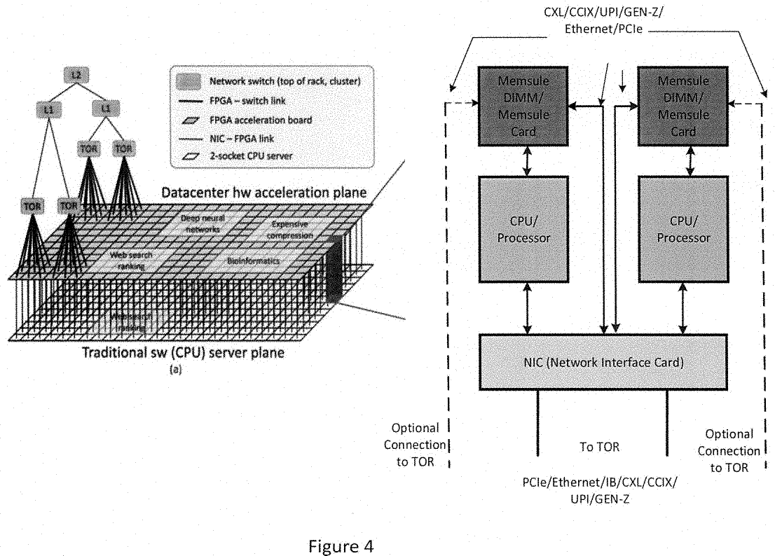

FIG. 4 illustrates an example of yet another system including storage class memory, configured in accordance with some embodiments. As shown in FIG. 4, SCM devices as disclosed herein may be implemented in a system that is a data center. Accordingly, as shown in FIG. 4, such a data center may include multiple servers having corresponding processors and SCM devices.

Such servers may be coupled to accelerator units. In various embodiments, the accelerator units may be FPGA acceleration boards specifically configured for computation acceleration of one or more applications, such as we search ranking, deep neural networks, bioinformatics, compression, and graphics rendering. In various embodiments, such accelerator units may be coupled to network devices, such as network switches which may be implemented atop racks and implemented in clusters.

Accordingly, as shown in FIG. 4, numerous devices including SCM devices may be implemented in parallel and communicatively coupled to provide connectivity between devices within a particular data center, and with devices implemented in other data centers.

Such servers may be coupled to accelerator units. In various embodiments, the accelerator units may be FPGA acceleration boards specifically configured for computation acceleration of one or more applications, such as we search ranking, deep neural networks, bioinformatics, compression, and graphics rendering. In various embodiments, such accelerator units may be coupled to network devices, such as network switches which may be implemented atop racks and implemented in clusters.

Accordingly, as shown in FIG. 4A, numerous devices including SCM devices may be implemented in parallel and communicatively coupled to provide connectivity between devices within a particular data center, and with devices implemented in other data centers. The accelerators may be inline or co-proc mode as shown in FIG. 4A.

While the present disclosure has been particularly shown and described with reference to specific embodiments thereof, it will be understood by those skilled in the art that changes in the form and details of the disclosed embodiments may be made without departing from the spirit or scope of the invention. Specifically, there are many alternative ways of implementing the processes, systems, and apparatuses described. It is therefore intended that the invention be interpreted to include all variations and equivalents that fall within the true spirit and scope of the present invention. Moreover, although particular features have been described as part of each example, any combination of these features or additions of other features are intended to be included within the scope of this disclosure. Accordingly, the embodiments described herein are to be considered as illustrative and not restrictive.

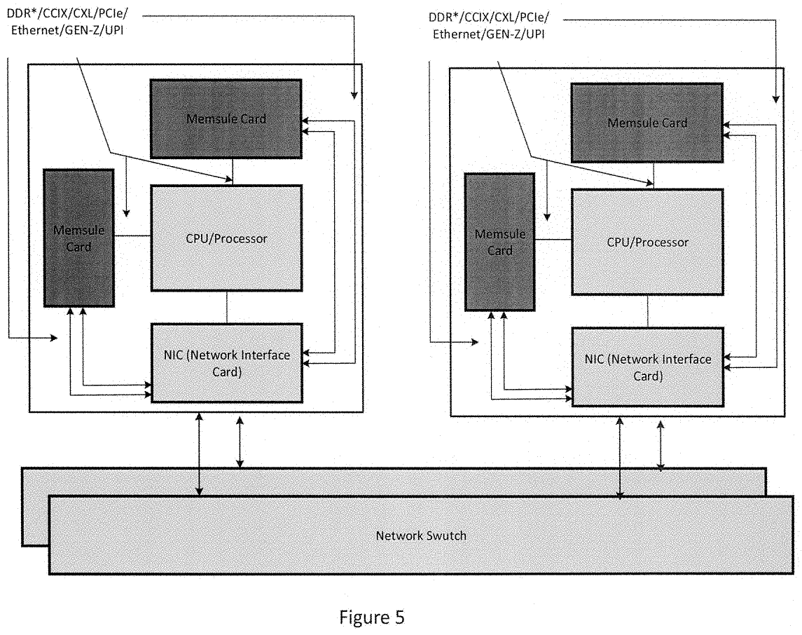

Reference will now be made in detail to some specific examples of the invention including the best modes contemplated by the inventors for carrying out the invention. Examples of these specific embodiments are illustrated in the accompanying drawings, i.e. FIG. 5-FIG. 8. While the present disclosure is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In addition, although many of the components and processes are described below in the singular for convenience, it will be appreciated by one of skill in the art that multiple components and repeated processes can also be used to practice the techniques of the present disclosure.

In the following description, numerous specific details are set forth in order to provide a thorough understanding of the present invention. Particular embodiments of the present invention may be implemented without some or all of these specific details. In other instances, well known process operations have not been described in detail in order not to unnecessarily obscure the present invention.

As will be discussed in greater detail below, systems disclosed herein are configured to create storage class memory dual in-line memory modules (SCM DIMMs) that are configured to implement any DDR protocols (e.g. DDR4/DDR5/DDR6/DDR7/DDR8, LPDDRx, or HBM* protocols) with connectivity of any generation of PCIe/IB/Ethernet/UPI/CXL/CCIX/GEN-Z connectivity. In this way, systems and devices implementing such SCM devices are able to carve out their own memory as private memory and shared pool memory. The shared portion can be shared via PCIe/IB/Ethernet/UPI/CXL/CCIX/GEN-Z switches and routers connected as end points in the network. In various embodiments, memory controllers included in the SCM devices are configured to cache memory pages, implement a learning engine based on AI algorithms to prefetch the pages to reduce the latency, and implement various security measures (SHA*, IPSec*, SSL*, ECDA*) to send/receive data securely on PCIe/IB/Ethernet/UPI/CXL/GEN-Z/CCIX network. The memory controller can be accessed as K/V pair where Key is supplied and the return value (entire page or multiple pages or a portion of page) can be delivered to requestor. Moreover, SCM devices as disclosed herein may be utilized to create a shared pool of memory accessible by accelerator units, and such a shared pool can be shared across multiple accelerator and/or compute units.

In various embodiments, management and control is also provided to the connected SCM devices to create memory centric computing. Such embodiments, may also be used to create a memory centric acceleration plane in a data center or across multiple data centers. The management of shared memory will manage the local memory vs the global pool. The management may be implemented by a number of servers and can serve one or more data centers.

In various embodiments, there are no specific driver requirements to access SCM DIMMs. The size of an SCM DIMM may appear infinite (infinite memory) to an associated processing or accelerator unit, and such memory may be configured and defined in an SPD (Serial presence detect) of the SCM device.

When the SCM devices disclosed herein are used to create GPU/AI clusters, the interface to SCM devices may be either standard DDR* or LPDDR* or GDDR*. The configurable 10 of the memory controller will provide access based on the interface protocol requirement.

As will be discussed in greater detail below, a cache, which may be a DDR cache, may be used to store some of the frequently accessed pages. These pages are learnt and identified based on application access patterns. In some embodiments, an AI algorithm is implemented to learn these access patterns and access the data apriori to reduce the latency to data.

In various embodiments, a networking and storage stack may be implemented as is for a server and application. A hardware/controller uses the networking protocol to transfer the data. This protocol will be reliable protocol over UDP/IP/Ethernet for scalability. Retransmissions are handled by hardware of the SCM devices such that no software driver is required by a processor/application associated with the SCM devices.

In various embodiments, management servers keep track of pages/local memory vs global memory pool. The segregation of the memory may be implemented at the time of boot. During runtime, the memory exposed to an application is infinite and the rest of the memory will be accessed by other servers in a rack or across the entire data center.

In some embodiments, an application accesses memory as if an infinite amount of memory exists. The application allocates the memory and if it is not available, a management server is notified and some part of the global pool of memory is reserved.

The reserved memory will be accessed by application.

According to various embodiments, all the accelerator units (which may be GPUs or ASICs) together appear as one large accelerator unit having billions of gates/cores, and higher level software implemented in one or more management servers may partition the work (processing operations) across multiple accelerator units.

FIG. 5 illustrates an example of a system including storage class memory, configured in accordance with some embodiments. In various embodiments, systems include a first server that includes SCM devices, and is configured to implement one or more functionalities associated with a first application which may be executed by or supported by systems disclosed herein. In various embodiments, the first server includes a first processor, which may be a central processing unit (CPU) that is configured to execute processing operations associated with the application. In various embodiments, the first processor is coupled to other components of the first server, such as a first SCM device, a second SCM device, and a network interface controller, which will be discussed in greater detail below.

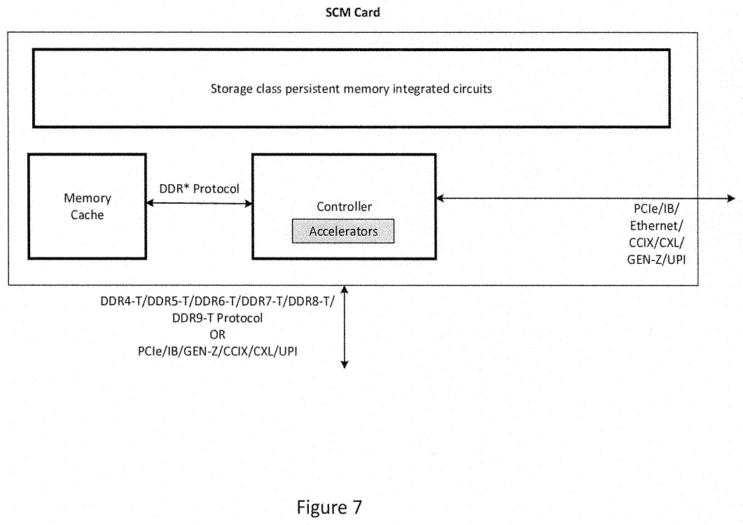

In various embodiments, the first SCM device is a configured to store data in a persistent manner. As will be discussed in greater detail below with reference to FIG. 7, SCM devices disclosed herein may be DIMM modules. As shown in FIG. 5, the first SCM device is communicatively coupled to other components of the first server, such as the first processor, and the first network interface controller. As also shown in FIG. 5, the first SCM device is directly coupled to the first network interface controller. In some embodiments, such coupling may be via an Ethernet port, and enables direct communication between the first SCM device and other network attached components. As will be discussed in greater detail below, such connectivity enables direct handling of read and write transactions by the first SCM device in a manner that bypasses the first CPU.

As shown in FIG. 5, the first server also includes a second SCM device which may be configured in a similar manner as the first SCM device. More specifically, the second SCM device may also be coupled to the first processor and the first network interface controller. While FIG. 5 illustrates the first server as having two SCM devices, it will be appreciated that the first server may have any number of SCM devices installed.

As discussed above, the first sever also includes the first network interface controller, which may be a network input/output chip that is configured to manage connectivity with other network components, such as network switches that may be coupled with the first server. Accordingly, the first network interface controller may facilitate communication between the first and second SCM devices and other components of other servers, as will be discussed in greater detail below.

As discussed above, systems disclosed herein may also include a second server that includes also SCM devices. The second server may be configured to implement one or more functionalities associated with a second application which may be executed by or supported by systems disclosed herein. As similarly discussed above, the second server includes a second processor, which may be a central processing unit (CPU) that is configured to execute processing operations associated with the second application. In various embodiments, the second processor is coupled to other components of the second server, such as a third SCM device, a fourth SCM device, and a second network interface controller, which will be discussed in greater detail below.

As similarly discussed above, the third SCM device is a configured to store data in a persistent manner. As shown in FIG. 5, the third SCM device is communicatively coupled to other components of the second server, such as the second processor, and the second network interface controller. As also shown in FIG. 5, the third SCM device is directly coupled to the second network interface controller. In some embodiments, such coupling may be via an Ethernet port, and enables direct communication between the third SCM device and other network attached components. As will be discussed in greater detail below, such connectivity enables direct handling of read and write transactions by the third SCM device in a manner that bypasses the second CPU.

As shown in FIG. 5, the second server also includes a fourth SCM device which may be configured in a similar manner as the third SCM device. More specifically, the fourth SCM device may also be coupled to the second processor and the second network interface controller. While FIG. 5 illustrates the second server as having two SCM devices, it will be appreciated that the second server may have any number of SCM devices installed.

As discussed above, the second sever also includes the second network interface controller, which may be a network input/output chip that is configured to manage connectivity with other network components, such as network switches that may be coupled with the second server. Accordingly, the second network interface controller may facilitate communication between the third and fourth SCM devices and other components of other servers, as will be discussed in greater detail below.

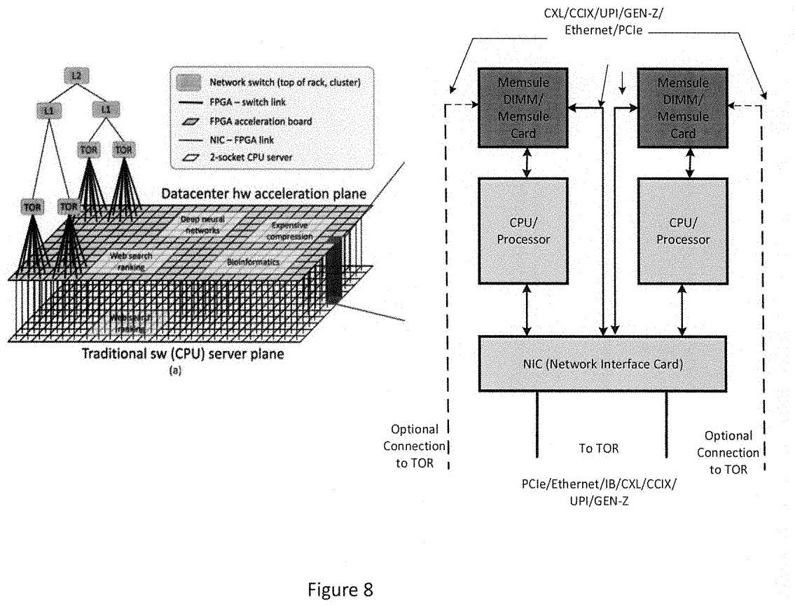

As also shown in FIG. 5, systems may include network switches which may be configured to handle the routing of data packets between servers. As will be discussed in greater detail below with reference to FIG. 8, servers may be implemented within an architecture of a data center. Accordingly, network switches may be used to route data between servers within a data center, and between servers in different data centers. Moreover, while the above description of FIG. 5 describes a first and second server, it will be appreciated that such systems may include numerous additional servers, and network switches may be configured to provide connectivity between all of the servers and their respective SCM devices.

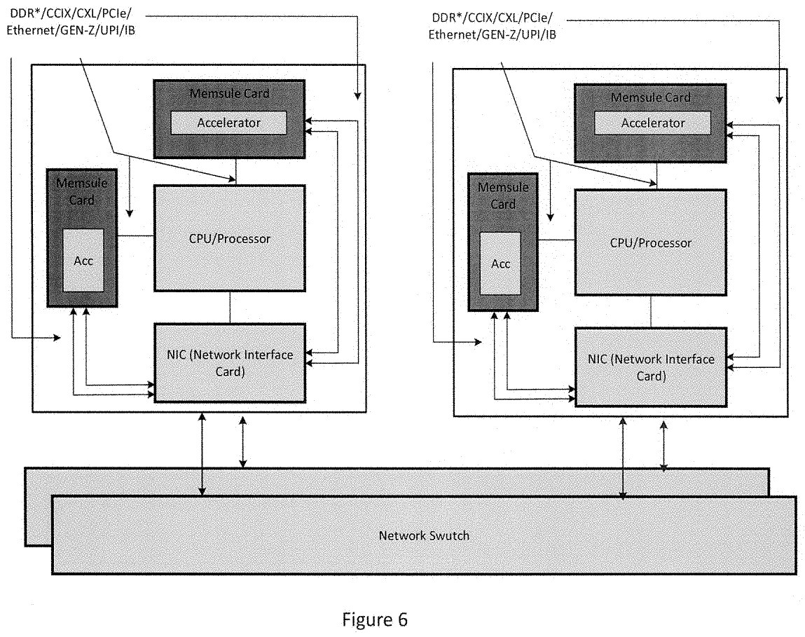

FIG. 6 illustrates an example of a system including storage class memory, configured in accordance with some embodiments. As similarly discussed above, systems may include various servers. For example, a system may include a first server that includes SCM devices, and is configured to implement one or more functionalities associated with a first application which may be executed by or supported by systems disclosed herein. In various embodiments, the first server includes a first processor, which may be a central processing unit (CPU) that is configured to execute processing operations associated with the application. As similarly discussed above, the first processor is coupled to other components of the first server, such as a second SCM device and a network interface controller that may be a may be a network input/output chip. While FIG. 5 illustrates the first server as having two SCM devices, it will be appreciated that the first server may have any number of SCM devices installed.

In various embodiments, the first server also includes a first accelerator unit that is configured to implement and accelerate particular processing operations. As shown in FIG. 6, the first accelerator unit may be coupled between the first processor and the first SCM device. In this way, the first accelerator unit may be communicatively coupled to the first processor and the first SCM device, and is configured to have direct communication with each of the first processor and the first SCM device. In various embodiments, the first accelerator unit is a graphics processing unit (GPU) that is configured to implement processing operations associated with graphics applications and graphical rendering. In some embodiments, the first accelerator unit is a hardware accelerator. According to various embodiments, the first accelerator unit is a neural processing unit (NPU) that is configured to implement processing operations associated with machine learning operations and deep learning techniques. In this way, the first accelerator unit may be specifically configured to implement particular processing operations, and may directly communicated with the first SCM device. As discussed in greater detail below, the first SCM device is coupled to the first network interface controller, and may be in communication with other SCM devices via a network to allocate memory and retrieve information as may be appropriate for the first accelerator unit.

As discussed above, systems disclosed herein may also include a second server that includes also SCM devices. The second server may be configured to implement one or more functionalities associated with a second application which may be executed by or supported by systems disclosed herein. As similarly discussed above, the second server includes a second processor, which may be a central processing unit (CPU) that is configured to execute processing operations associated with the second application. In various embodiments, the second processor is coupled to other components of the second server, such as a fourth SCM device and a second network interface controller that may be a may be a network input/output chip. While FIG. 6 illustrates the second server as having two SCM devices, it will be appreciated that the second server may have any number of SCM devices installed.

In various embodiments, the second server also includes a second accelerator unit that is configured to implement and accelerate particular processing operations. As similarly discussed above, the second accelerator unit may be coupled between the second processor and the third SCM device. In this way, the second accelerator unit may be communicatively coupled to the second processor and the third SCM device, and is configured to have direct communication with each of the second processor and the third SCM device. As similarly discussed above, the second accelerator unit may be a graphics GPU, a hardware accelerator, or an NPU. As similarly discussed above, the third SCM device is coupled to the second network interface controller, and may be in communication with other SCM devices via a network to allocate memory and retrieve information as may be appropriate for the second accelerator unit.

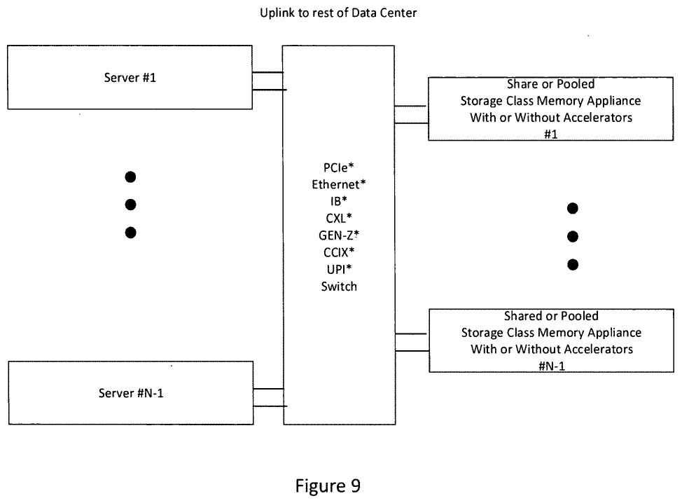

As also shown in FIG. 6, systems may include network switches which may be configured to handle the routing of data packets between servers. As will be discussed in greater detail below with reference to FIG. 9, servers may be implemented within an architecture of a data center. Accordingly, network switches may be used to route data between servers within a data center, and between servers in different data centers. Moreover, while the above description of FIG. 6 describes a first and second server, it will be appreciated that such systems may include numerous additional servers, and network switches may be configured to provide connectivity between all of the servers and their respective SCM devices.

FIG. 7 illustrates an example of a device including storage class memory, configured in accordance with some embodiments. As discussed above, SCM devices as disclosed herein are configured to store data values that may be utilized in computational operations. As will be discussed in greater detail below, SCM devices disclosed herein are dual in-line memory modules (DIMMs) that are configured to couple with other system components via DIMM slots and utilizing one or more protocols, such as DDR4-T/DDR5-T/DDR6-T/DDR7-T/DDR8-T/DDR9-T as well as DDR4/DDR5/DDR6/DDR7/DDR8. As will also be discussed in greater detail below, such SCM devices are configured to implement persistent storage at such DIMM slots, and in a manner that may bypass another system component, such as a processing unit, to implement various transactions, such as read and write transactions.

In various embodiments SCM devices may include SCM persistent memory integrated circuits configured to implement persistent storage of data values. Accordingly, such SCM persistent memory integrated circuits are configured to provide addressable memory that is configured to store data values in a persistent manner that retains data after the device has been shut off. As will be discussed in greater detail below, such data values may be read and written to and from SCM persistent memory integrated circuits utilizing memory transactions, such as read and write transactions.

In some embodiments, SCM devices may include a memory cache which is a memory device configured to store frequently utilized data values. For example, memory cache is configured to store frequently accessed pages. These pages are identified based on one or more identified access patterns. For example, an application utilizing the SCM devices may access the data values stored in the SCM persistent memory integrated circuits in accordance with a particular pattern. One or more components of the SCM devices, such as a memory controller discussed in greater detail below, may be configured to identify and learn these access patterns and access the data apriori to reduce the latency to data.

As discussed above, an SCM device may also include a memory controller that is configured to control the flow of data between a processing unit and the SCM device using a plurality of transactions including read and write transactions. As shown in FIG. 7, the memory controller may be coupled to the memory cache and SCM persistent memory integrated circuits. Moreover, as will be discussed in greater detail below, the memory controller may also be coupled to other system components, such as a processor, and other SCM devices via a communications interface and a network interface, respectively. In some embodiments, the memory controller has a configurable I/O that is configured to implement a particular transfer protocol. For example, the memory controller may be configured to implement a protocol consistent with DDR* or LPDDR* or GDDR*.

In various embodiments, the memory controller is configured to configure and define portions of the memory provided by the SCM persistent memory integrated circuits. For example, the memory controller is configured to define a local pool of memory that is utilized by the system or device that is coupled to the SCM device. The memory controller is also configured to define a shared pool of memory that may be utilized by other network attached SCM devices. In this way, a portion of the memory of the SCM device may form a portion of a shared pool of memory that may be allocated to and utilized by processing units or accelerator units in communication with the SCM devices participating in the shared pool. In various embodiments, the memory controller is also configured to track the amount of memory included in the local and shared portions of its associated SCM device, and may store that information in a serial presence detect (SPD) portion of the SCM device.

In various embodiments, SCM devices may further include a network interface that is configured to facilitate transactions between the SCM persistent memory integrated circuits and other SCM devices. In various embodiments, the network interface has a unique Media Access Control (MAC) address. Moreover, the network interface is configured to facilitate data transfers. In some embodiments, the network interface may be a PCI express interface or an Ethernet port. Accordingly, the network interface may be communicatively coupled to a communications network, and may enable communication between the memory controller, as well as the SCM persistent memory integrated circuits, and memory controllers and SCM persistent memory integrated circuits of other SCM devices. In this way, SCM devices are configured to conduct data transfers via the network interface in a manner that bypasses other components, such as a processing unit.

In some embodiments, SCM devices may also include a communications interface that is configured to enable communications with one or more other system components. For example, the communications interface may enable communications between the SCM devices and a processing unit, as will be discussed in greater detail below. Accordingly, the communications interface is coupled to the memory controller and is configured to facilitate communications between the memory controller and the processing unit. In some embodiments, the communications interface includes pins that may be inserted in a DIMM slot.

FIG. 8 illustrates an example of yet another system including storage class memory, configured in accordance with some embodiments. As shown in FIG. 8, SCM systems as disclosed herein may be implemented as part of a larger system that is a data center. Accordingly, as shown in FIG. 8, such a data center may include multiple servers having corresponding processors and SCM devices.

Such servers may be coupled to accelerator units. In various embodiments, the accelerator units may be FPGA acceleration boards specifically configured for computation acceleration of one or more applications, such as we search ranking, deep neural networks, bioinformatics, compression, and graphics rendering. In various embodiments, such accelerator units may be coupled to network devices, such as network switches which may be implemented atop racks and implemented in clusters.

Accordingly, as shown in FIG. 8, numerous devices including SCM devices may be implemented in parallel and communicatively coupled to provide connectivity between devices within a particular data center, and with devices implemented in other data centers.

While the present disclosure has been particularly shown and described with reference to specific embodiments thereof, it will be understood by those skilled in the art that changes in the form and details of the disclosed embodiments may be made without departing from the spirit or scope of the invention. Specifically, there are many alternative ways of implementing the processes, systems, and apparatuses described. It is therefore intended that the invention be interpreted to include all variations and equivalents that fall within the true spirit and scope of the present invention. Moreover, although particular features have been described as part of each example, any combination of these features or additions of other features are intended to be included within the scope of this disclosure. Accordingly, the embodiments described herein are to be considered as illustrative and not restrictive.

Reference will now be made in detail to some specific examples of the invention including the best modes contemplated by the inventors for carrying out the invention. Examples of these specific embodiments are illustrated in the accompanying drawings, FIG. 9 to FIG. 12. While the present disclosure is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In addition, although many of the components and processes are described below in the singular for convenience, it will be appreciated by one of skill in the art that multiple components and repeated processes can also be used to practice the techniques of the present disclosure.

In the following description, numerous specific details are set forth in order to provide a thorough understanding of the present invention. Particular embodiments of the present invention may be implemented without some or all of these specific details. In other instances, well known process operations have not been described in detail in order not to unnecessarily obscure the present invention.

The System will create SCM DIMMs with Any DDR Protocols E.g.

DDR4/DDR5/DDR6/DDR7/DDR8 or LPDDRx or HBM* protocols with connectivity of any generation of PCIe/IB/Ethernet/CXL/UPI/CCIX/GEN-Z connectivity. This controller provides the basis of this patent. It allows any server to carve out it's own memory as private memory and shared pool memory. The shared portion can be shared via PCIe/IB/Ethernet/CXL/UPICCIX/GEN-Z switches and routers connected end points in the network. The controller has many proprietary protocols built in to cache the memory pages, learning engine based on AI algorithms to prefetch the pages to reduce the latency, security (SHA*, IPSec*, SSL*, ECDA* algorithms) to send/receive data securely on PCIe/IB/Ethernet/UPI/CCIX/CXL/GEN-Z network. The controller can be accessed as K/V pair where Key is supplied and the return value (entire page or multiple pages or a portion of page can be delivered to requestor).

As will be discussed in greater detail below, latency sensitive applications will benefit with SCM devices (also referred to herein as Memsule devices or Memsule DIMMs). Such latency sensitive applications may be data base applications, search applications, artificial intelligence/machine learning applications, internet of things and industrial internet of things, autonomous cars, as well as advertisement insertion. It will be appreciated that such benefits may be provided to any latency sensitive application.

In various embodiments, management and control is also provided to the connected SCM devices to create memory centric computing. Such embodiments, may also be used to create a memory centric acceleration plane in a data center or across multiple data centers. The management of shared memory will manage the local memory vs the global pool. The management may be implemented by a number of servers and can serve one or more data centers.

In various embodiments, there are no specific driver requirements to access SCM DIMMs. The size of an SCM DIMM may appear infinite (infinite memory) to an associated processing or accelerator unit, and such memory may be configured and defined in an SPD (Serial presence detect) of the SCM device.

When the SCM devices disclosed herein are used to create GPU/AI clusters, the interface to SCM devices may be either standard DDR* or LPDDR* or GDDR*. The configurable IO of the memory controller will provide access based on the interface protocol requirement.

As will be discussed in greater detail below, a cache, which may be a DDR cache, may be used to store some of the frequently accessed pages. These pages are learnt and identified based on application access patterns. In some embodiments, an AI algorithm is implemented to learn these access patterns and access the data apriori to reduce the latency to data.

In various embodiments, a networking and storage stack may be implemented as is for a server and application. A hardware/controller uses the networking protocol to transfer the data. This protocol will be reliable protocol over UDP/IP/Ethernet for scalability. Retransmissions are handled by hardware of the SCM devices such that no software driver is required by a processor/application associated with the SCM devices.

In various embodiments, management servers keep track of pages/local memory vs global memory pool. The segregation of the memory may be implemented at the time of boot. During runtime, the memory exposed to an application is infinite and the rest of the memory will be accessed by other servers in a rack or across the entire data center.

In some embodiments, an application accesses memory as if an infinite amount of memory exists. The application allocates the memory and if it is not available, a management server is notified and some part of the global pool of memory is reserved.

The reserved memory will be accessed by application.

According to various embodiments, all the accelerator units (which may be GPUs or ASICs) together appear as one large accelerator unit having billions of gates/cores, and higher level software implemented in one or more management servers may partition the work (processing operations) across multiple accelerator units.

FIG. 9 illustrates an example of a system including storage class memory appliances, configured in accordance with some embodiments. As shown in FIG. 9, a system may include SCM memory appliances that are implemented as part of a larger computing system. In one example, such a larger system may be a data center. Accordingly, the system may include various servers, such as a first server and a second server. In various embodiments, such servers are configured to execute one or more processing functions which may support an application that is supported by the data center. In some embodiments. While FIG. 9 has been shown with two servers, it will be appreciated that any number of servers may be utilized in the embodiments disclosed herein.

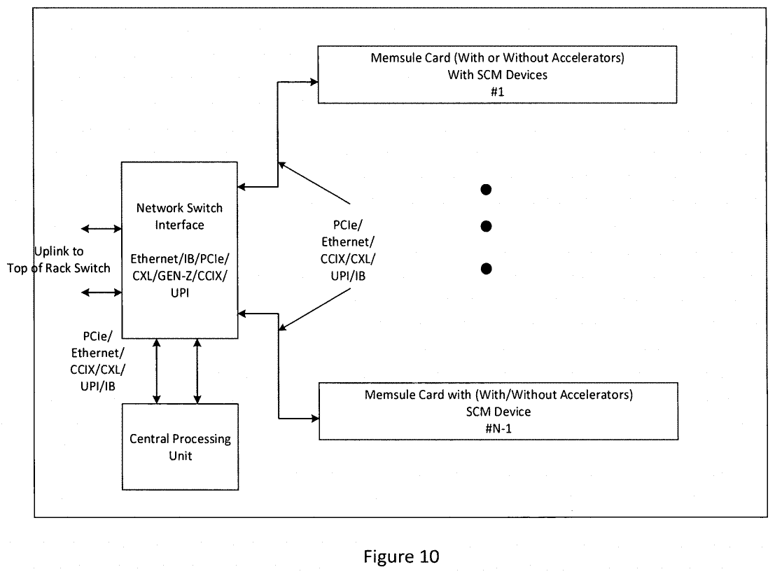

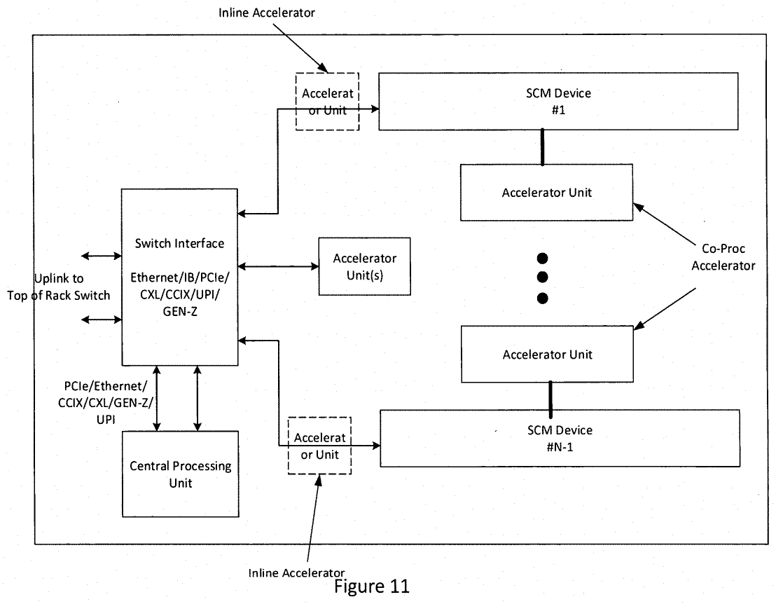

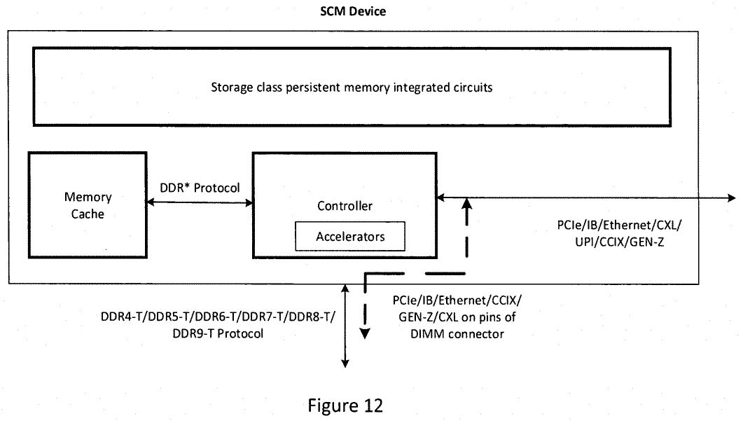

As shown in FIG. 9, the system may also include one or more storage class memory appliances, such as first storage class memory appliance, and second storage class memory appliance. In various embodiments a storage class memory appliance is configured to include storage class memory devices. As will be discussed in greater detail below with reference to FIG. 12, storage class memory devices may be memory modules that are configured to provide addressable memory for applications in a manner that bypasses a host CPU. Moreover, as will be discussed in greater detail below, such storage class memory devices may be controlled by the storage class memory appliance to provide a pool of shared persistent memory that may be shared amongst the servers, and allocated to the servers as needed. Additional details of the storage class memory appliances are discussed in greater detail below with reference to FIG. 10 and FIG. 11.

In various embodiments, systems may further include network switches which are configured to provide connectivity between the servers and storage class memory appliances, and the rest of the data center as well as components of other data centers.

FIG. 10 illustrates an example of a storage class memory appliance, configured in accordance with some embodiments. As discussed above, a storage class memory appliance may be a system or device that may interface with a larger system and provide a configurable shared pool of persistent memory to components of the larger system. For example, the storage class memory appliance may be a memory sled or rack that can be installed in a data center, and can provide persistent memory to other components of the data center, such as other servers implemented in the data center.

Accordingly, the storage class memory appliance may include multiple SCM devices, such as a first SCM device and a second SCM device. As will be discussed in greater detail below with reference to FIG. 11, SCM devices may be configured as DIMM modules. Accordingly, a storage class memory appliance may include multiple SCM devices, and the SCM devices may collectively provide a pool of shared persistent memory that can be used by the servers.

In some embodiments, the shared memory is provided utilizing memory translation tables that include page table pointers and MAC addresses associated with the SCM devices. In this way, storage locations of pages may be tracked, and transfer of pages from SCM devices may be managed. As will be discussed in greater detail below, the SCM devices are configured to handle such transfers directly and without the use of a host processor. The memory translation tables may be managed by the control processor, discussed below, or may be managed by processors on board each of the SCM devices. The tables may be stored in a memory of the storage class memory appliance, may be stored at the servers, and may be stored in multiple locations for redundancy purposes.

As discussed above, storage class memory appliances may include a control processor that is configured to manage the shared pool of persistent memory provided by the SCM devices included in the storage class memory appliance.

Accordingly, the control processor may assist in the initial allocation of memory to applications supported by servers, and may handle dynamic allocation or data migration as well. In this way, the control processor may be configured to implement management operations across the entire shared pool of persistent memory, and may also be configured to communicate with control processors of other storage class memory appliances to coordinate operations or transactions with those storage class memory appliances, or migrate data to and from those storage class memory appliances.

In some embodiments, storage class memory appliance further includes a network switch interface that is configured to provide connectivity between the control processor and SCM devices, and other components of a system in which the storage class memory appliance is implemented. For example, the network switch interface may provide connectivity between the SCM devices and the control processor, and other servers implemented in a data center. In various embodiments, storage class memory appliances may also include a cache which is configured to store frequently accessed data, such as frequently accessed pages.

FIG. 11 illustrates an example of another storage class memory appliance, configured in accordance with some embodiments. As discussed above, storage class memory appliances may include SCM devices, such as a first SCM device and a second SCM device, as well as a control processor, a network switch interface, and a cache. As shown in FIG. 11, storage class memory appliances may also include various accelerator units that are configured to implement specific processing functionalities or operations. Accordingly, storage class memory appliances may include first accelerator unit and second accelerator unit.

In various embodiments, an accelerator unit may be a hardware accelerator configured to implement specific processing functions. Accordingly, the hardware accelerator may be an application specific integrated circuit (ASIC). In some embodiments, accelerator units are graphics processing units (GPUs). Accordingly, SCM devices may be configured to directly communicate with a GPU, or a cluster of GPUs. In various embodiments, accelerator units may be a neural processing units (NPUs) configured to implement one or more machine learning operations. Accordingly, when configured as an NPU, the accelerator unit is configured accelerate machine learning operations implemented by systems disclosed herein. While FIG. 11 illustrates two accelerator units, it will be appreciated that any number of accelerator units may be implemented.

In various embodiments, the accelerator units included in a storage class memory appliance are implemented as a cluster of accelerator units and are managed such that a client entity, such as a server or an application associated with the server, that is utilizing the cluster of accelerator units sees a single accelerator unit. In this way, the storage class memory appliance is configured to provide clustered accelerator unit processing capabilities and pooled persistent memory in a manner that is not visible to the client entity, and appears as a single memory and a single accelerator unit to the client entity.

FIG. 12 illustrates an example of a device including storage class memory, configured in accordance with some embodiments. As discussed above, SCM devices as disclosed herein are configured to store data values that may be utilized in computational operations. As will be discussed in greater detail below, SCM devices disclosed herein are dual in-line memory modules (DIMMs) that are configured to couple with other system components via DIMM slots and utilizing one or more protocols, such as DDR4-T/DDR5-T/DDR6-T/DDR7-T/DDR8-T/DDR9-T as well as DDR4/DDR5/DDR6/DDR7/DDR8. As will also be discussed in greater detail below, such SCM devices are configured to implement persistent storage at such DIMM slots, and in a manner that may bypass another system component, such as a processing unit, to implement various transactions, such as read and write transactions.

In various embodiments SCM devices may include SCM persistent memory integrated circuits configured to implement persistent storage of data values. Accordingly, such SCM persistent memory integrated circuits are configured to provide addressable memory that is configured to store data values in a persistent manner that retains data after the device has been shut off. As will be discussed in greater detail below, such data values may be read and written to and from SCM persistent memory integrated circuits utilizing memory transactions, such as read and write transactions.

In some embodiments, SCM devices may include a memory cache which is a memory device configured to store frequently utilized data values. For example, memory cache is configured to store frequently accessed pages. These pages are identified based on one or more identified access patterns. For example, an application utilizing the SCM devices may access the data values stored in the SCM persistent memory integrated circuits in accordance with a particular pattern. One or more components of the SCM devices, such as a memory controller discussed in greater detail below, may be configured to identify and learn these access patterns and access the data apriori to reduce the latency to data.

As discussed above, an SCM device may also include a memory controller that is configured to control the flow of data between a processing unit and the SCM device using a plurality of transactions including read and write transactions. As shown in FIG. 12, the memory controller may be coupled to the memory cache and SCM persistent memory integrated circuits. Moreover, as will be discussed in greater detail below, the memory controller may also be coupled to other system components, such as a processor, and other SCM devices via a communications interface and a network interface, respectively. In some embodiments, the memory controller has a configurable I/O that is configured to implement a particular transfer protocol. For example, the memory controller may be configured to implement a protocol consistent with DDR* or LPDDR* or GDDR*.

In various embodiments, the memory controller is configured to configure and define portions of the memory provided by the SCM persistent memory integrated circuits. For example, the memory controller is configured to define a local pool of memory that is utilized by the system or device that is coupled to the SCM device. The memory controller is also configured to define a shared pool of memory that may be utilized by other network attached SCM devices. In this way, a portion of the memory of the SCM device may form a portion of a shared pool of memory that may be allocated to and utilized by processing units or accelerator units in communication with the SCM devices participating in the shared pool. In various embodiments, the memory controller is also configured to track the amount of memory included in the local and shared portions of its associated SCM device, and may store that information in a serial presence detect (SPD) portion of the SCM device.

In various embodiments, SCM devices may further include a network interface that is configured to facilitate transactions between the SCM persistent memory integrated circuits and other SCM devices. In various embodiments, the network interface has a unique Media Access Control (MAC) address. Moreover, the network interface is configured to facilitate data transfers. In some embodiments, the network interface may be a PCI express interface or an Ethernet port. Accordingly, the network interface may be communicatively coupled to a communications network, and may enable communication between the memory controller, as well as the SCM persistent memory integrated circuits, and memory controllers and SCM persistent memory integrated circuits of other SCM devices. In this way, SCM devices are configured to conduct data transfers via the network interface in a manner that bypasses other components, such as a processing unit.

In some embodiments, SCM devices may also include a communications interface that is configured to enable communications with one or more other system components. For example, the communications interface may enable communications between the SCM devices and a processing unit, as will be discussed in greater detail below. Accordingly, the communications interface is coupled to the memory controller and is configured to facilitate communications between the memory controller and the processing unit. In some embodiments, the communications interface includes pins that may be inserted in a DIMM slot.

While the present disclosure has been particularly shown and described with reference to specific embodiments thereof, it will be understood by those skilled in the art that changes in the form and details of the disclosed embodiments may be made without departing from the spirit or scope of the invention. Specifically, there are many alternative ways of implementing the processes, systems, and apparatuses described. It is therefore intended that the invention be interpreted to include all variations and equivalents that fall within the true spirit and scope of the present invention. Moreover, although particular features have been described as part of each example, any combination of these features or additions of other features are intended to be included within the scope of this disclosure. Accordingly, the embodiments described herein are to be considered as illustrative and not restrictive.

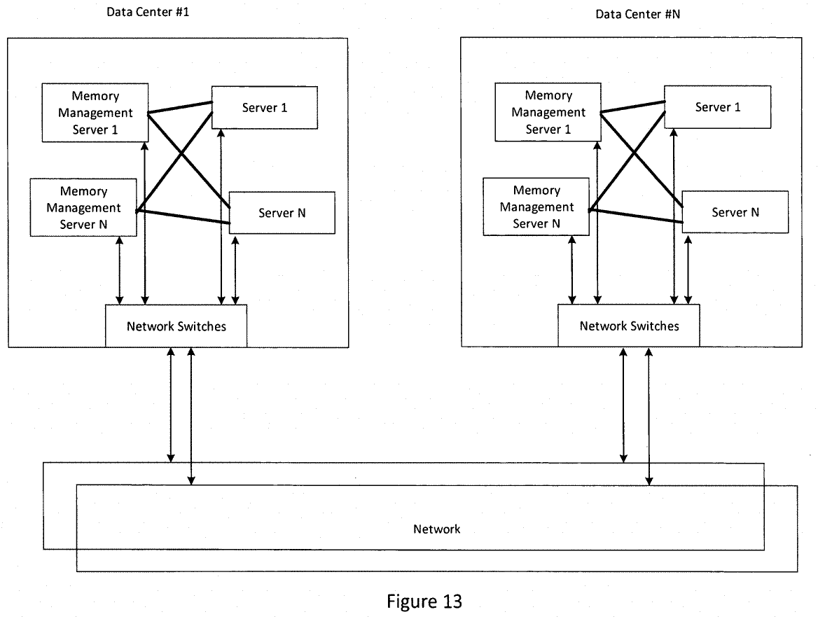

Reference will now be made in detail to some specific examples of the invention including the best modes contemplated by the inventors for carrying out the invention. Examples of these specific embodiments are illustrated in the accompanying drawings, i.e. FIG. 13-FIG. 16. While the present disclosure is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In addition, although many of the components and processes are described below in the singular for convenience, it will be appreciated by one of skill in the art that multiple components and repeated processes can also be used to practice the techniques of the present disclosure.

In the following description, numerous specific details are set forth in order to provide a thorough understanding of the present invention. Particular embodiments of the present invention may be implemented without some or all of these specific details. In other instances, well known process operations have not been described in detail in order not to unnecessarily obscure the present invention.

As will be discussed in greater detail below, systems disclosed herein are configured to create storage class memory dual in-line memory modules (SCM DIMMs) that are configured to implement any DDR protocols (e.g. DDR4/DDR5/DDR6/DDR7/DDR8, LPDDRx, or HBM* protocols) with connectivity of any generation of PCIe/IB/Ethernet/CXL/CCIX/UPI/GEN-Z connectivity. In this way, systems and devices implementing such SCM devices are able to carve out their own memory as private memory and shared pool memory. The shared portion can be shared via PCIe/IB/Ethernet/CXL/CCIX/UPI/GEN-Z switches and routers connected as end points in the network. In various embodiments, memory controllers included in the SCM devices are configured to cache memory pages, implement a learning engine based on AI algorithms to prefetch the pages to reduce the latency, and implement various security measures (SHA*, IPSec*, SSL*, ECDA*, Comp/De-comp, Security, Erasure codes, KTLS) to send/receive data securely on PCIe/IB/Ethernet/CXL/CCIX/GEN-Z/UPI network. The memory controller can be accessed as K/V pair where Key is supplied and the return value (entire page or multiple pages or a portion of page) can be delivered to requestor. Moreover, SCM devices as disclosed herein may be utilized to create a shared pool of memory accessible by accelerator units, and such a shared pool can be shared across multiple accelerator and/or compute units.

As will be discussed in greater detail below, latency sensitive applications will benefit with SCM devices (also referred to herein as Memsule devices or Memsule DIMMs). Such latency sensitive applications may be data base applications, search applications, artificial intelligence/machine learning applications, internet of things and industrial internet of things, autonomous cars, as well as advertisement insertion. It will be appreciated that such benefits may be provided to any latency sensitive application.

In various embodiments, management and control is also provided to the connected SCM devices to create memory centric computing. Such embodiments, may also be used to create a memory centric acceleration plane in a data center or across multiple data centers. The management of shared memory will manage the local memory vs the global pool. The management may be implemented by a number of servers and can serve one or more data centers.

In various embodiments, there are no specific driver requirements to access SCM DIMMs. The size of an SCM DIMM may appear infinite (infinite memory) to an associated processing or accelerator unit, and such memory may be configured and defined in an SPD (Serial presence detect) of the SCM device.

When the SCM devices disclosed herein are used to create GPU/AI clusters, the interface to SCM devices may be either standard DDR* or LPDDR* or GDDR*. The configurable IO of the memory controller will provide access based on the interface protocol requirement.

As will be discussed in greater detail below, a cache, which may be a DDR cache, may be used to store some of the frequently accessed pages. These pages are learnt and identified based on application access patterns. In some embodiments, an AI algorithm is implemented to learn these access patterns and access the data apriori to reduce the latency to data.

In various embodiments, a networking and storage stack may be implemented as is for a server and application. A hardware/controller uses the networking protocol to transfer the data. This protocol will be reliable protocol over UDP/IP/Ethernet for scalability. Retransmissions are handled by hardware of the SCM devices such that no software driver is required by a processor/application associated with the SCM devices.

In various embodiments, management servers keep track of pages/local memory vs global memory pool. The segregation of the memory may be implemented at the time of boot. During runtime, the memory exposed to an application is infinite and the rest of the memory will be accessed by other servers in a rack or across the entire data center.

In some embodiments, an application accesses memory as if an infinite amount of memory exists. The application allocates the memory and if it is not available, a management server is notified and some part of the global pool of memory is reserved.

The reserved memory will be accessed by application.

According to various embodiments, all the accelerator units (which may be GPUs or ASICs) together appear as one large accelerator unit having billions of gates/cores, and higher level software implemented in one or more management servers may partition the work (processing operations) across multiple accelerator units.

FIG. 13 illustrates an example of a system including storage class memory, configured in accordance with some embodiments. In various embodiments, SCM devices may be deployed in a variety of environments, such as a data center. As shown in FIG. 13, multiple data centers may be communicatively coupled to each other, and components within each data center may communicate with components of other data centers to implement memory management and memory transactions utilizing SCM devices within and/or across data centers.

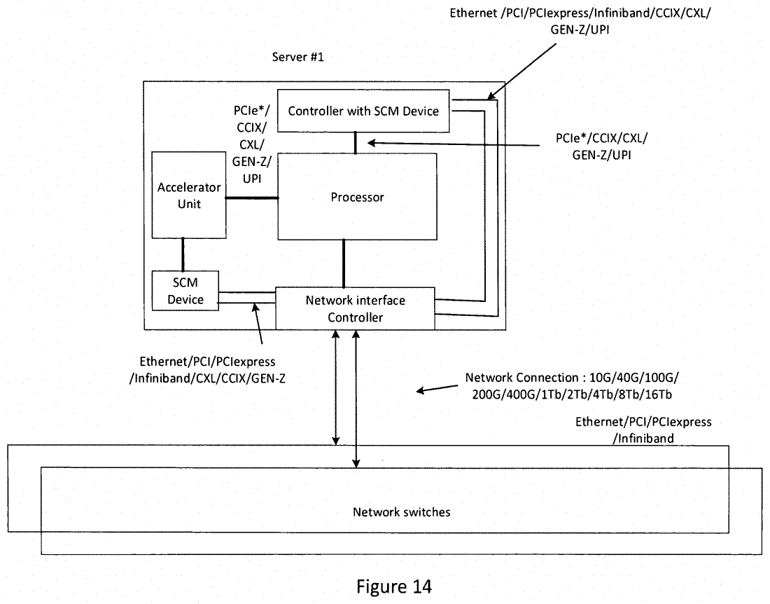

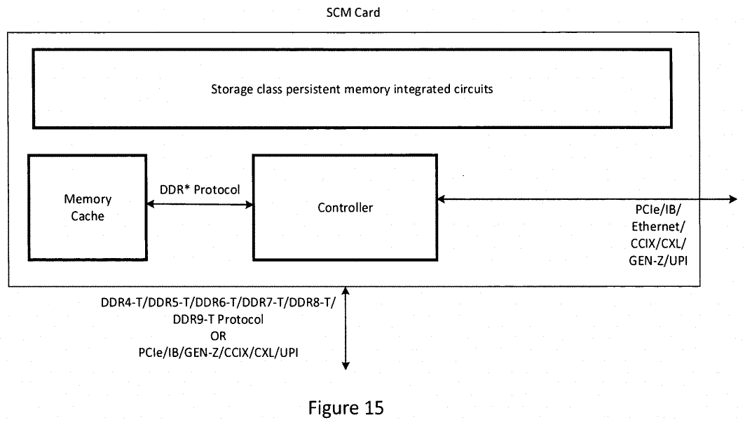

In various embodiments, systems include a first data center and a second data center. As shown in FIG. 13, the first data center may include various SCM devices that may be included in various servers, such as a first server and a second server. In some embodiments, the SCM devices may be implemented as standalone storage class memory appliances that can be installed as a memory sled or rack. Additional details of the servers and SCM devices will be discussed in greater detail below with reference to FIG. 14 and FIG. 15.

In various embodiments the first data center may also include various memory management servers, such as first memory management server and second memory management server. Each memory management server may be configured to communicate with each of the servers, as well as each of the SCM devices included in each server. In this way, a memory management server is communicatively coupled to each of the SCM devices in a shared memory pool, and may manage the implementation of the share memory pool.

As will be discussed in greater detail below with reference to FIG. 15, the memory management servers may be configured to track which applications are implemented on which servers, and are further configured to handle the allocation of memory from a shared memory pool to those applications. In some embodiments, the memory management servers are configured to implement the allocation based on one or more parameters, such as a geographical proximity, interface type, and/or connection speed or latency. In this way, the memory management servers may configure the portion of the shared pool of memory that is allocated to a server in a manner that reduces latency and provides access that is as fast as reasonably possible. In some embodiments, the memory management server is further configured to implement data migration from one SCM device to another to, for example, meet a geographical proximity parameter, and reduce latency. In various embodiments, the memory management servers are also configured to facilitate the implementation of various security measures, and/or compliance with one or more security parameters. Additional details of the operation of the memory management servers is discussed in greater detail below with reference to FIG. 15.

As also shown in FIG. 13, systems may include an additional data center, such as second data center. In some embodiments, the second data center also includes memory management servers, as well as servers that include SCM devices and that are configured to support one or more application. Accordingly, memory management servers may communicate with each other, and with SCM devices included in servers of other data centers. In this way, a shared pool of persistent memory may be implemented across multiple data centers, and memory allocated to an application may be implemented in a distributed manner, or may be migrated to be handled by SCM devices in a single data center.

In various embodiments, the first and second data centers may include network switches which may be coupled to a network. Accordingly, the data centers are configured to communicate with each other, and components within each data center are configured to communicate with each other via such switches and network.

FIG. 14 illustrates another example of a system including storage class memory, configured in accordance with some embodiments. As similarly discussed above, systems may include various servers. For example, a system may include a server that includes SCM devices, and is configured to implement one or more functionalities associated with an application which may be executed by or supported by systems disclosed herein. In various embodiments, the server includes a processor, which may be a central processing unit (CPU) that is configured to execute processing operations associated with the application. As similarly discussed above, the processor is coupled to other components of the server, such as a second SCM device and a network interface controller that may be a may be a network input/output chip. While FIG. 14 illustrates the server as having two SCM devices, it will be appreciated that the server may have any number of SCM devices installed.

In various embodiments, the server also includes an accelerator unit that is configured to implement and accelerate particular processing operations. As shown in FIG. 14, the accelerator unit may be coupled between the processor and a first SCM device. In this way, the accelerator unit may be communicatively coupled to the processor and the first SCM device, and is configured to have direct communication with each of the processor and the first SCM device. In various embodiments, the accelerator unit is a graphics processing unit (GPU) that is configured to implement processing operations associated with graphics applications and graphical rendering. In some embodiments, the accelerator unit is a hardware accelerator. According to various embodiments, the accelerator unit is a neural processing unit (NPU) that is configured to implement processing operations associated with machine learning operations and deep learning techniques. In this way, the accelerator unit may be specifically configured to implement particular processing operations, and may directly communicated with the first SCM device. As similarly discussed above, the first SCM device is coupled to a network interface controller, and may be in communication with other SCM devices via a network to allocate memory and retrieve information as may be appropriate for the accelerator unit:

As also shown in FIG. 14, systems may include network switches which may be configured to handle the routing of data packets between servers. As discussed above, servers may be implemented within an architecture of a data center. Accordingly, network switches may be used to route data between servers within a data center, and between servers in different data centers. Moreover, while the above description of FIG. 14 describes a particular server, it will be appreciated that any of the servers included in systems described herein may include components as described in FIG. 14, and network switches may be configured to provide connectivity between all of the servers and their respective SCM devices.

FIG. 15 illustrates an example of a device including storage class memory, configured in accordance with some embodiments. As discussed above, SCM devices as disclosed herein are configured to store data values that may be utilized in computational operations. As will be discussed in greater detail below, SCM devices disclosed herein are dual in-line memory modules (DIMMs) that are configured to couple with other system components via DIMM slots and utilizing one or more protocols, such as DDR4-T/DDR5-T/DDR6-T/DDR7-T/DDR8-T/DDR9-T as well as DDR4/DDR5/DDR6/DDR7/DDR8. As will also be discussed in greater detail below, such SCM devices are configured to implement persistent storage at such DIMM slots, and in a manner that may bypass another system component, such as a processing unit, to implement various transactions, such as read and write transactions.

In various embodiments SCM devices may include SCM persistent memory integrated circuits configured to implement persistent storage of data values. Accordingly, such SCM persistent memory integrated circuits are configured to provide addressable memory that is configured to store data values in a persistent manner that retains data after the device has been shut off. As will be discussed in greater detail below, such data values may be read and written to and from SCM persistent memory integrated circuits utilizing memory transactions, such as read and write transactions.

In some embodiments, SCM devices may include a memory cache which is a memory device configured to store frequently utilized data values. For example, memory cache is configured to store frequently accessed pages. These pages are identified based on one or more identified access patterns. For example, an application utilizing the SCM devices may access the data values stored in the SCM persistent memory integrated circuits in accordance with a particular pattern. One or more components of the SCM devices, such as a memory controller discussed in greater detail below, may be configured to identify and learn these access patterns and access the data apriori to reduce the latency to data.

As discussed above, an SCM device may also include a memory controller that is configured to control the flow of data between a processing unit and the SCM device using a plurality of transactions including read and write transactions. As shown in FIG. 15, the memory controller may be coupled to the memory cache and SCM persistent memory integrated circuits. Moreover, as will be discussed in greater detail below, the memory controller may also be coupled to other system components, such as a processor, and other SCM devices via a communications interface and a network interface, respectively. In some embodiments, the memory controller has a configurable I/O that is configured to implement a particular transfer protocol. For example, the memory controller may be configured to implement a protocol consistent with DDR* or LPDDR* or GDDR*.

In various embodiments, the memory controller is configured to configure and define portions of the memory provided by the SCM persistent memory integrated circuits. For example, the memory controller is configured to define a local pool of memory that is utilized by the system or device that is coupled to the SCM device. The memory controller is also configured to define a shared pool of memory that may be utilized by other network attached SCM devices. In this way, a portion of the memory of the SCM device may form a portion of a shared pool of memory that may be allocated to and utilized by processing units or accelerator units in communication with the SCM devices participating in the shared pool. In various embodiments, the memory controller is also configured to track the amount of memory included in the local and shared portions of its associated SCM device, and may store that information in a serial presence detect (SPD) portion of the SCM device.

In various embodiments, SCM devices may further include a network interface that is configured to facilitate transactions between the SCM persistent memory integrated circuits and other SCM devices. In various embodiments, the network interface has a unique Media Access Control (MAC) address. Moreover, the network interface is configured to facilitate data transfers. In some embodiments, the network interface may be a PCI express interface or an Ethernet port. Accordingly, the network interface may be communicatively coupled to a communications network, and may enable communication between the memory controller, as well as the SCM persistent memory integrated circuits, and memory controllers and SCM persistent memory integrated circuits of other SCM devices. In this way, SCM devices are configured to conduct data transfers via the network interface in a manner that bypasses other components, such as a processing unit.

In some embodiments, SCM devices may also include a communications interface that is configured to enable communications with one or more other system components. For example, the communications interface may enable communications between the SCM devices and a processing unit, as will be discussed in greater detail below. Accordingly, the communications interface is coupled to the memory controller and is configured to facilitate communications between the memory controller and the processing unit. In some embodiments, the communications interface includes pins that may be inserted in a DIMM slot.

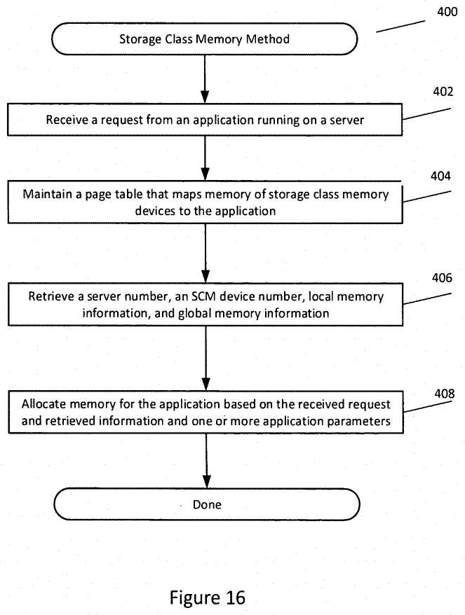

FIG. 16 illustrates an example of a method for using storage class memory, implemented in accordance with some embodiments. As will be discussed in greater detail below, memory management servers and SCM devices are configured to handle the allocation of memory to an application from a shared pool of persistent memory, and also handle the implementation of one or more parameters to ensure that such allocation is implemented in an efficient manner that reduces latency.

The method may commence with receiving a request from an application running on a server, the request being received at a memory controller. In various embodiments, the request may be a memory transaction request, such as a request associated with a read or write transaction.

The method may proceed with maintaining a page table that includes page numbers, server numbers, SCM DIMM numbers, and pointers mapping blocks of memory to SCM DIMMs connected to the server associated with the request. In various embodiments, such pointers may be local pointers that point to a global location in the shared pool of persistent memory. As discussed above, the SCM DIMMs may be included in the server, or may be connected to the server via a network interface. Moreover, such a table may be stored as part of one or more caching operations.

The method may proceed with retrieving a server number and an SCM DIMM number for an SCM DIMM associated with the server, based on the request and the previously maintained page table. The method may also proceed with retrieving local and global memory information from an SPD of the identified SCM DIMM. The local and global memory information may identify an amount of memory reserved as local memory in the SCM DIMM, and an amount of global memory available as shared memory for a shared pool. It will be appreciated that while such information is discussed with reference to a particular SCM DIMM associated with the requesting server, there may be numerous SCM DIMMs associated with the requesting server, and such information may be retrieved for numerous SCM devices, or a cluster of SCM devices. In some embodiments, the reading of the SPD may be accomplished by utilizing a BIOS.

The method may proceed with allocating memory using the request from the application, wherein whether the memory is locally allocated or remotely allocated remains transparent to the application. In one example, if an amount of memory requested exceeds an amount that is locally available.

In various embodiments, if the request includes a request that exceeds an amount of local memory that is available in the identified SCM DIMM, a request may be sent for additional memory from the shared pool of persistent memory. In one example, such a request may be send from the SCM DIMM to a memory management server, and the memory management server may allocate the memory from the shared pool, and in accordance with the application requirements and parameters discussed above. Once allocated, the SCM DIMMs may communicate with each other directly, and bypass a host CPU.

In various embodiments, the SCM devices are configured to implement the transmission of data, and retransmission of data in a manner specifically configured for the memory centric computing disclosed herein. For example, SCM devices are configured to transmit data utilizing data packets that are also configured to include various information such as DMAC, SMAC, server number, DIMM number, and page number. In this way, the data packets sent between SCM devices are specifically configured to include identification information specific to the SCM devices disclosed herein, and such information may be used for the purposes of allocation of shared persistent memory across SCM devices, and utilization of such shared memory.

Moreover, the SCM devices may be further configured to implement retransmission techniques to ensure reliability of transmission. Other techniques, such as TCP, may be unreliable, so SCM devices as disclosed herein may be configured to implement retransmission operations when transmitting data packets. More specifically, the SCM devices themselves may be configured to generate and transmit the data packets, generate and receive confirmation messages, and retransmit if appropriate. Furthermore, in addition to retransmission techniques, the SCM devices may also be configured to implement one or more security measures, such as implementation of data encryption and decryption of the data packets that are sent and received at SCM devices.

While the present disclosure has been particularly shown and described with reference to specific embodiments thereof, it will be understood by those skilled in the art that changes in the form and details of the disclosed embodiments may be made without departing from the spirit or scope of the invention. Specifically, there are many alternative ways of implementing the processes, systems, and apparatuses described. It is therefore intended that the invention be interpreted to include all variations and equivalents that fall within the true spirit and scope of the present invention. Moreover, although particular features have been described as part of each example, any combination of these features or additions of other features are intended to be included within the scope of this disclosure. Accordingly, the embodiments described herein are to be considered as illustrative and not restrictive.

What is claimed is:

1. A storage class memory (SCM) dual in-line memory module (DIMM), comprising:
a memory controller associated with the SCM DIMM, the memory controller being configured to control the flow of data between a processing unit and the SCM DIMM using a plurality of transactions including read and write transactions;
a plurality of SCM persistent memory integrated circuits included on the SCM DIMM; and
a network interface included on the SCM DIMM, the network interface having a unique Media Access Control address, wherein the SCM DIMM is operable to conduct data transfers over the network interface while bypassing the processing unit.

2. The SCM DIMM of claim 1, wherein the processing unit is a central processing unit (CPU).

3. The SCM DIMM of claim 1, wherein the processing unit is a graphics processing unit (GPU).

4. The SCM DIMM of claim 1, wherein the processing unit is a hardware accelerator.

5. The SCM DIMM of claim 1, wherein the processing unit is a neural processing unit (NPU).

6. Server, comprising:
a central processing unit;
a hardware accelerator connected to the central processing unit;
a network input/output (I/O) chip connected to the central processing unit;
a storage class memory (SCM) dual-inline memory module (DIMM) connected to the central processing unit through the central processing unit interface, connected to the hardware accelerator through a hardware accelerator interface, and connected to the network I/O chip through a network interface included in the SCM DIMM.

7. A storage class memory appliance, comprising:
a network switch interface;
a control processor connected to the network switch interface, wherein the storage class memory appliance is coupled to a network switch connecting a plurality of servers to the storage class memory appliance;
a plurality of storage class memory (SCM) dual-inline memory modules (DIMMs) connected to the network switch interface, wherein the SCM DIMMs are configured to provide a pool of shared persistent memory to the plurality of servers through the use of memory translation tables included at the plurality of servers, the memory translation tables including a plurality of page table pointers and a plurality of MAC addresses,
wherein the plurality of the SCM DIMMs are connected to a plurality of processing units.

8. A method, comprising:
receiving a request from an application running on a server, the request received at a memory controller;
maintaining a page table comprising page numbers, server numbers, storage class memory (SCM) dual-inline memory module (DIMM) numbers, and pointers mapping blocks of memory to SCM DIMMs in devices connected to the server through a network interface;
allocating memory using the request from the application, wherein whether the memory is locally allocated or remotely allocated remains transparent to the application.
